(19) United States
(12) Patent Application Publication
(10) Pub. No.: US 2014/0180574 A1
(43) Pub. Date: Jun. 26, 2014

(54) ELECTRONIC DEVICE AND METHOD FOR UPDATING RENDEZVOUS LOCATION OF COMMUNICATION DEVICES

(71) Applicant: Hon Hai Precision Industry Co., Ltd., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/082,222

(22) Filed: Nov. 18, 2013

(30) Foreign Application Priority Data
Dec. 20, 2012 (TW) 101148855

(51) Int. Cl. G01C 21/00

(52) U.S. Cl. CPC G01C 21/00
USPC 701/420

(57) ABSTRACT

In a method for updating a rendezvous location of communication devices using an electronic device, the electronic device connects to a host device through a wireless network. The electronic device includes a global positioning system (GPS), a displacement sensor, and a display screen. The electronic device sends basic information of the rendezvous event to a back-end system of the host device through the wireless network, detects location information of each communication device using the GPS, and detects a displacement information of each communication device using the displacement sensor. The electronic device sends the location information and the displacement information to the host device to determine a rendezvous location, a guide route, and relative location relationships of each communication device, marks the rendezvous location, the guide route, and the relative location relationships on an electronic map, and displays the marked electronic map on the display screen.

### BACKGROUND

1. Technical Field

Embodiments of the present disclosure relate to information updating systems and methods, and particularly to an electronic device and a method for updating a rendezvous location of communication devices.

2. Description of Related Art

An increasing number of wireless communications devices or mobile devices have a Global Positioning System (GPS) system that provides location data. This location data may be used for navigation or other location-based services. This enables users of the devices to remember a specific location or to return to the rendezvous location at a later time. One type of information obtainable by processing the location data of the devices is a rendezvous location, however, a method of calculating the rendezvous location and distributing the rendezvous location to communication devices is inadequate in the prior art. Therefore, there is room for improvement within the prior art.

### BRIEF DESCRIPTION OF THE DRAWINGS

FIG. 1 is a block diagram of one embodiment of an electronic device including a rendezvous updating system.

FIG. 2 is a flowchart of one embodiment of a method for updating a rendezvous location of communication devices.

FIG. 3A, FIG. 3B, FIG. 3C and FIG. 3D show one embodiment of a user interface of the rendezvous updating system.

FIG. 4A, FIG. 4B and FIG. 4C shows one embodiment of setting basic information of a rendezvous event using the user interface of the rendezvous updating system.

FIG. 5 shows one embodiment of marking an electronic map when a shortest distance from the rendezvous location is set as a direction condition of a rendezvous event.

FIG. 6 shows one embodiment of marking the electronic map when a shortest time of the rendezvous event is set as the direction condition.

FIG. 7 shows one embodiment of marking the electronic map when an average distance from the rendezvous location is set as the direction condition.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

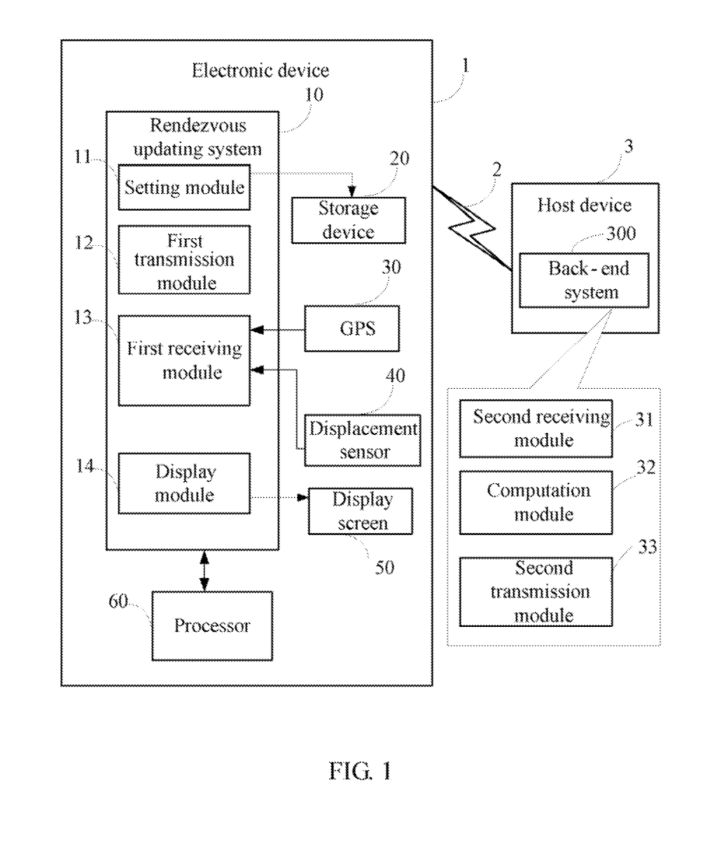

FIG. 1 is a block diagram of one embodiment of an electronic device 1 including a rendezvous updating system 10. In the embodiment, the rendezvous updating system 10 comprises computerized instructions in the form of one or more computer-readable programs, which are implemented by the electronic device 1. The electronic device 1 connects to a host device 3 through a wireless network 2. The electronic device 1 further includes, but is not limited to, a storage device 20, a global positioning system (GPS) 30, a displacement sensor 40, a display screen 50, and at least one processor 60. The electronic device 1 can be a notebook computer, a mobile device, a personal digital assistant (PDA), or other communication device. The host device 3 can be a personal computer, a server, a workstation computer or other computing device.

The rendezvous updating system 10 includes, but is not limited to, a setting module 11, a first transmission module 12, a first receiving module 13, and a display module 14. The modules 11-14 can comprise computerized instructions in the form of one or more computer-readable programs that are stored in a non-transitory computer-readable storage medium (such as the storage device 20) and executed by the at least one processor 60.

The storage device 20 stores an electronic map that provides location information and navigation route for communication devices, such as a notebook computers, a mobile devices, or a personal digital assistant (PDA) devices. Each of the communication devices may includes the rendezvous updating system 10 of the electronic device 1 to update the rendezvous location for the communication device. In one embodiment, the storage device 20 can be an internal storage system, such as a flash memory, a random access memory (RAM) for temporary storage of information, and/or a read only memory (ROM) for permanent storage of information. The storage device 20 can also be an external storage system, such as an external hard disk, a storage card, or a data storage medium.

The GPS 30 provides the location information that may be used for navigation or other location-based services for the communication devices. The displacement sensor 40 detects a displacement of each of the communication devices in real time. The at least one processor 60 is a central processing unit (CPU) or microprocessor that performs various functions of the electronic device 1.

The host device 3 includes a back-end system 300 comprises computerized instructions in the form of one or more computer-readable programs, which are implemented by the host device 3. In the embodiment, the back-end system 300 includes a second receiving module 31, a computation module 32, and a second transmission module 33. The modules 31-33 can comprise computerized instructions in the form of one or more computer-readable programs that are stored in a non-transitory computer-readable storage medium and executed by a processor of the host device 3.

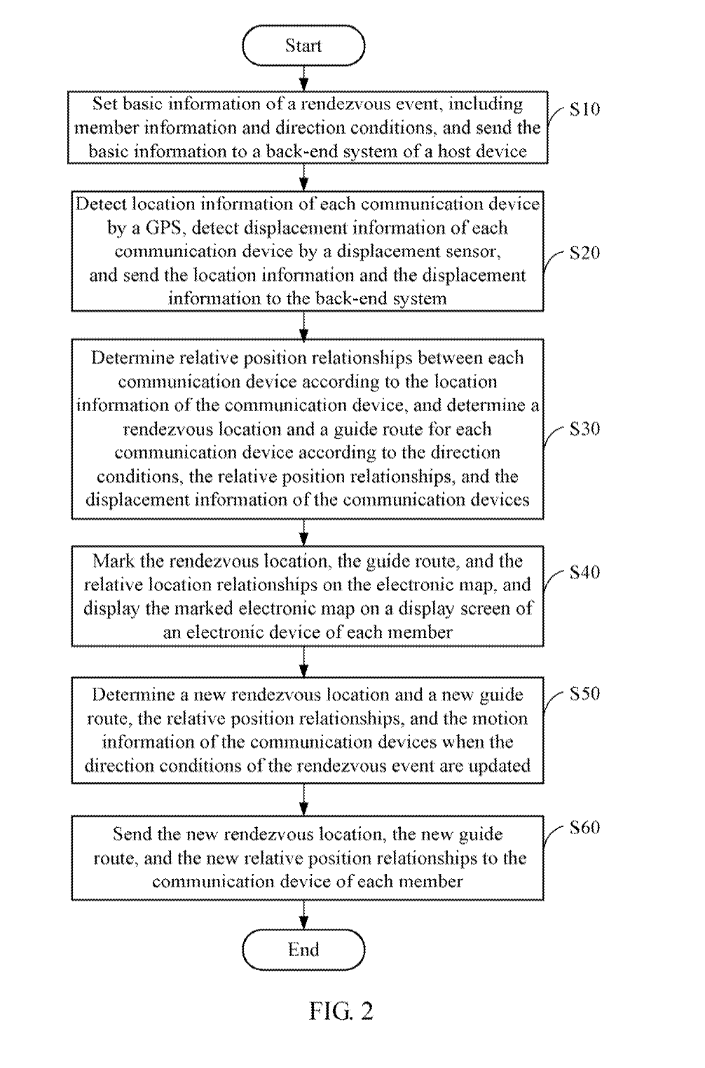

FIG. 2 is a flowchart of one embodiment of a method of updating a rendezvous location of communication devices using the electronic device 1. In one embodiment, the method is performed by execution of computer-readable software program codes or instructions by the at least one processor 60 of the electronic device 1. Depending on the embodiment, additional steps may be added, others removed, and the ordering of the steps may be changed.

In step S10, the setting module 11 sets basic information of a rendezvous event when a member of the electronic device 1 enters the rendezvous updating system 10, and the first transmission module 12 sends the basic information to a back-end system 300 of the host device 3 through the wireless network 2. The basic information can include member information and direction conditions of the rendezvous event. In the embodiment, a plurality of members can join in the rendezvous event, and each of the members has a communication device identical to the electronic device 1 as shown in FIG. 1.

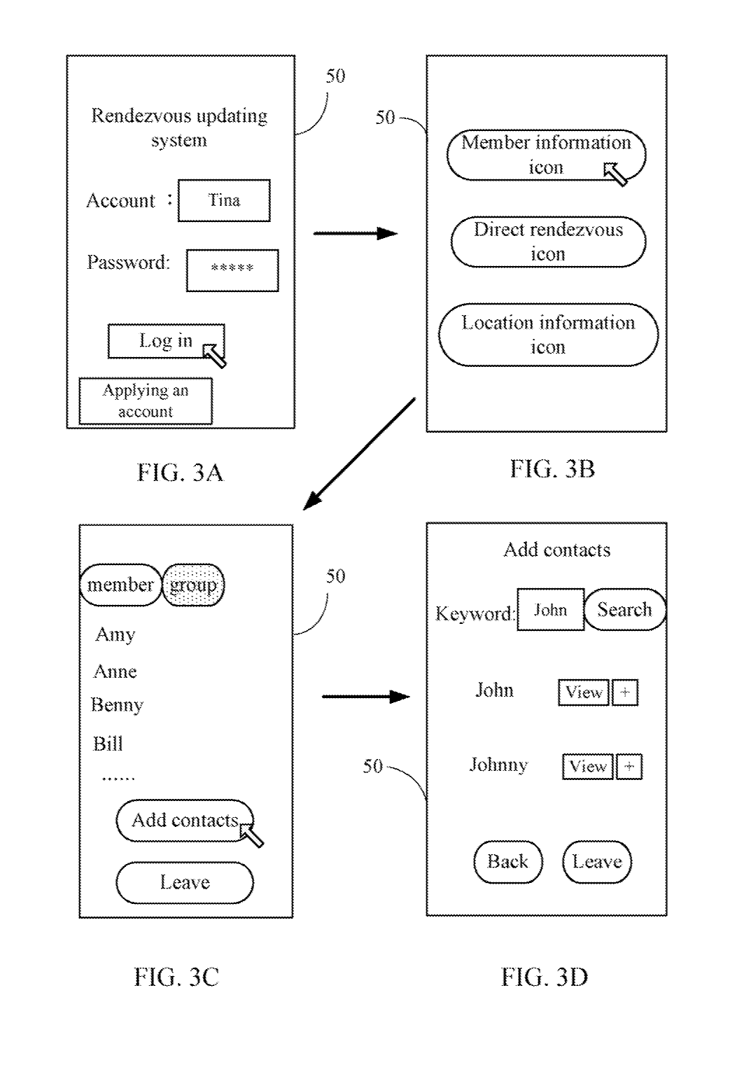

FIG. 3A shows that the rendezvous updating system 10 displays a user interface on the display screen 50 when the rendezvous updating system 10 is invoked, and each of the members uses an account (such as Tina) and a password to log in the rendezvous updating system 10 through the user interface. FIG. 3B shows that a user of the electronic device 1 can click a member information icon to set the member information of the rendezvous event, click a direct rendezvous icon to set the rendezvous direction of the rendezvous event, and click a location information icon to browse the location information of the members. FIG. 3C shows that the member can view each member of the rendezvous event, such as named “Amy,” “Anne,” “Benny,” and “Bill.” The user also can select one or more members to establish a rendezvous group using an add contact icon of the user interface. FIG. 3D shows that the user can search contact information stored in the electronic device 1 by inputting a keyword such as a member named “John” from a keyword box of the user interface.

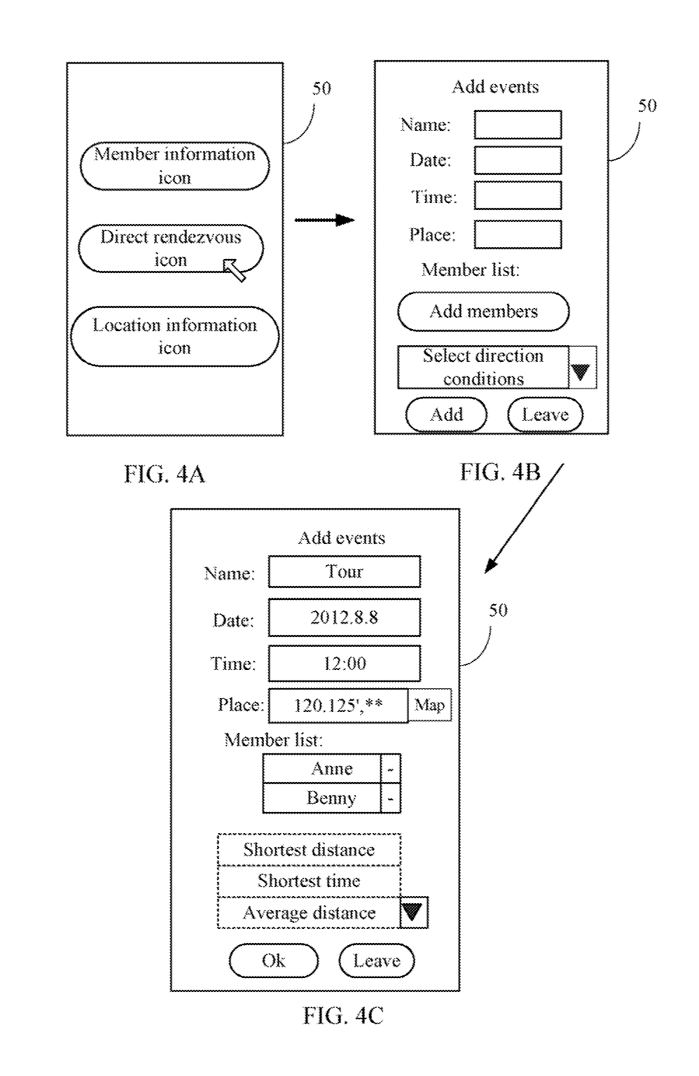

FIG. 4A shows that the member can set the rendezvous direction of the rendezvous event by the direct rendezvous icon of the user interface. FIG. 4B shows that the member can set a name of the rendezvous event, a date of the rendezvous event, a time of the rendezvous event, and a location of the rendezvous event, and selects a direction condition through the user interface. FIG. 4C shows that the name of the rendezvous event is set as “Tour,” the date of the rendezvous event is set as “2012-08-08”, the time of the rendezvous event is set as “12pm”, and the direction condition of the rendezvous event can be selected from the electronic map. In the embodiment, the direction condition of the rendezvous event includes a shortest distance to the rendezvous location, a shortest time reaching the rendezvous event, and an average distance to the rendezvous location.

After the basic information of the rendezvous event is set, the first transmission module 12 sends the basic information to the back-end system 300 of the host device 3 through the wireless network 2. The host device 3 stores the basic information of the rendezvous event in a storage system of the host device 3 when the second receiving module 31 of the host device 3 receives the basic information of the rendezvous event sent from the electronic device 1.

In step S20, the first receiving module 13 receives location information of each communication device detected by the GPS 30, and receives a displacement information of each communication device detected by the displacement sensor 40, and the first transmission module 12 sends the location information and the displacement information to the back-end system 300 of the host device 3 through the wireless network 2. For example, if the members of the rendezvous event includes the members named “Anne,” “Benny,” and “Tina”, the location information including a longitude and latitude information is detected by the GPS 30, and the displacement information including a direction and a speed of each communication device is detected by the displacement sensor 40.

In step S30, the computation module 32 of the host device 3 determines a relative location relationship between each of the communication devices according to the location information of the communication devices, and determines a rendezvous location and a guide route for each communication device according to the direction conditions, the relative location relationships, and the motion information of the communication devices.

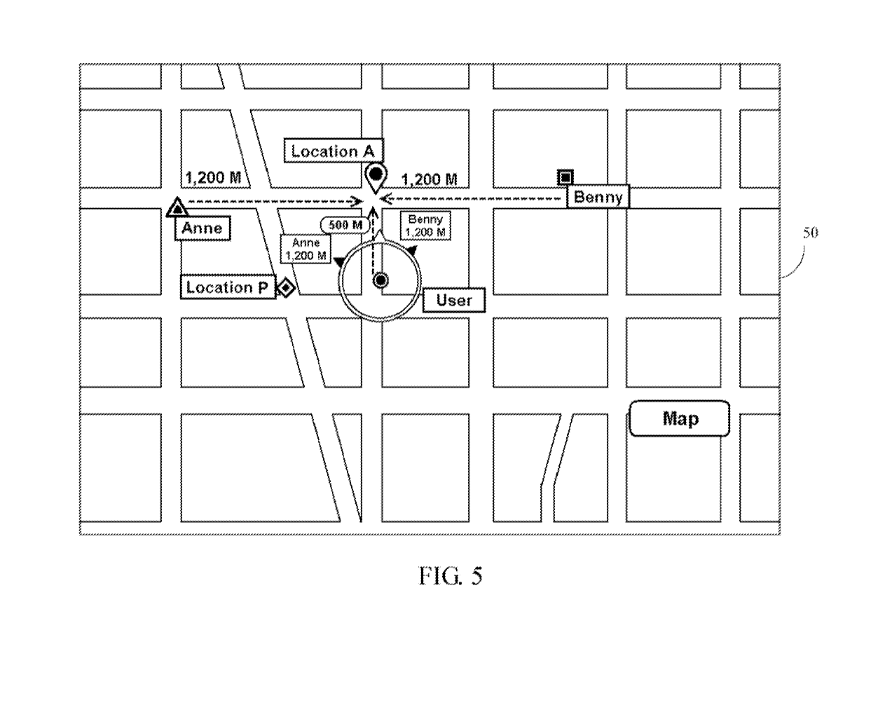

Referring to FIG. 5, if the member of the rendezvous event selects the shortest distance to the rendezvous as the direction condition, the computation module 32 obtains the location information of the members including “Anne,” “Benny,” and “Tina,” and determines the location “A” as the rendezvous location and the shortest guide route for each member according to the location information of the members.

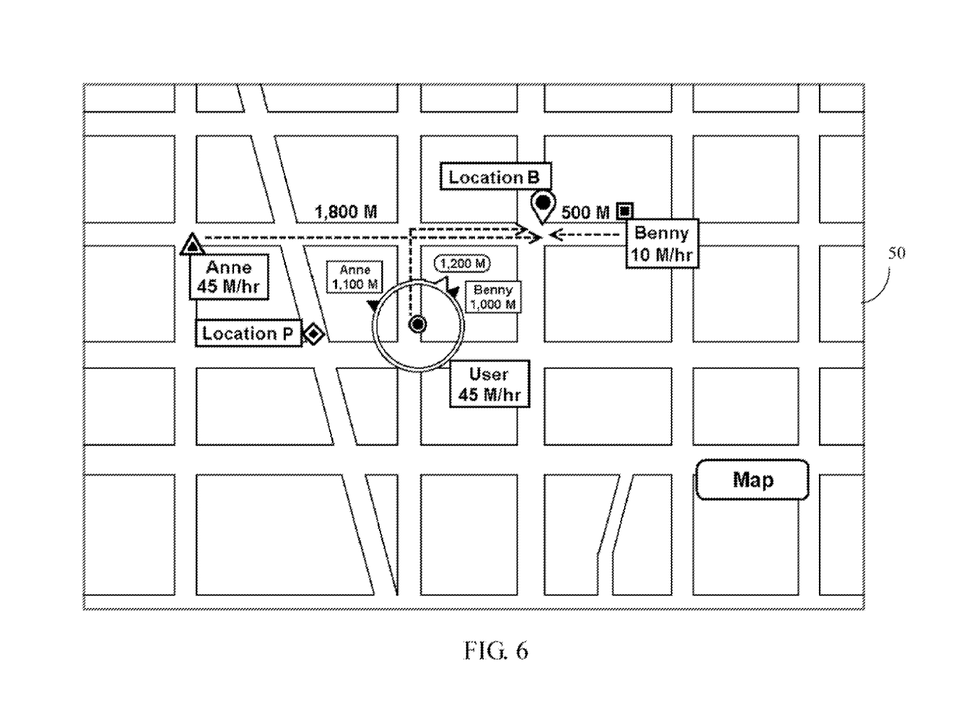

Referring to FIG. 6, if the member of the rendezvous event selects the shortest time reaching the rendezvous event as the direction condition, the computation module 32 obtains the location information of the members including “Anne,” “Benny,” and “Tina,” and determines the location “B” as the rendezvous location and the guide route for each member according to the location information of the members.

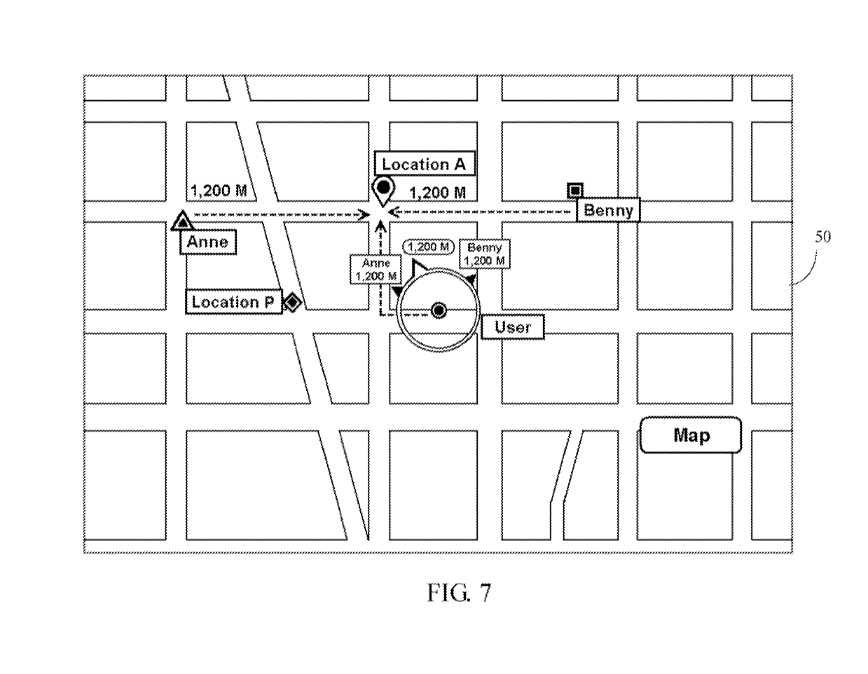

Referring to FIG. 7, if the member of the rendezvous event selects the average distance to the rendezvous as the direction condition, the computation module 32 obtains the location information of the members including “Anne,” “Benny,” and “Tina,” and determines the location “A” as the rendezvous location and the guide route for each member according to the location information of the members.

In step S40, the first receiving module 13 receives the rendezvous location, the guide route for each communication device, and the relative location relationships to the electronic device 1 of each communication device. The display module 14 marks the rendezvous location, the guide route for each communication device, and the relative location relationships on the electronic map, and displays the marked electronic map on the display screen 50.

In the embodiment, the display module 14 marks the rendezvous location on the electronic map using a location indicator. The location indicator includes a first indicator indicating the guide route for each communication device, and a second indicator indicating a distance between each communication device and the rendezvous location. The location indicator can be an annulus indicator, a circle indicator, a triangle indicator, and rectangle indicator.

In step S50, the computation module 32 receives an updated direction condition when the member updates the direction condition through the user interface, and determines a new rendezvous location and a new guide route for each communication device according to the updated direction condition, the relative location relationships, and the motion information of the communication devices.

In step S60, the second transmission module 33 sends the new rendezvous location, the new guide route for each member, and the new relative location relationships to the electronic device 1 of each member. The display module 14 marks the new rendezvous location, the new guide route for each member, and the new relative location relationships on the electronic map, and displays the marked electronic map on the display screen 50.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device for updating a rendezvous location of communication devices, the electronic device being connected to a host device through a wireless network, the electronic device comprising:
a global positioning system (GPS), a displacement sensor, a display screen, and at least one processor; and
a storage device storing a computer-readable program including instructions that, which when executed by the at least one processor, causes the at least one processor to:
set basic information of a rendezvous event including member information and direction conditions of the rendezvous event;
send the basic information of the rendezvous event to a back-end system of the host device through the wireless network;
receive location information of each communication device detected by the GPS, and receive a displacement information of each communication device detected by the displacement sensor;
send the location information and the displacement information to the back-end system of the host device to determine a rendezvous location, a guide route for each communication device, and relative location relationships of each communication device;
receive the rendezvous location, the guide route for each communication device, and the relative location relationships of each communication device sent from the host computer; and mark the rendezvous location, the guide route for each communication device, and the relative location relationships on an electronic map, and display the marked electronic map on the display screen.

2. The electronic device according to claim 1, wherein the direction conditions of the rendezvous event comprise a shortest distance to the rendezvous location, a shortest time reaching the rendezvous event, and an average distance to the rendezvous location.

3. The electronic device according to claim 1, wherein the rendezvous location is marked on the electronic map using a location indicator, and the location indicator comprising a first indicator indicating the guide route for each communication device, and a second indicator indicating a distance between each communication device and the rendezvous location.

4. The electronic device according to claim 3, wherein the location indicator is an annulus indicator, a circle indicator, a triangle indicator, or a rectangle indicator.

5. The electronic device according to claim 1, wherein the back-end system determines the relative location relationship between each of the members according to the location information of the communication devices, and determines the rendezvous location and a guide route for each communication device according to the direction conditions and the relative location relationships.

6. The electronic device according to claim 1, wherein the member information of the rendezvous event is set using a member information icon, the direction condition of the rendezvous event is set using a direct rendezvous icon, and the location information of each communication device is set using a location information icon.

7. A method of updating a rendezvous location of communication devices using an electronic device, the electronic device being connected to a host device through a wireless network, the electronic device comprising a global positioning system (GPS), a displacement sensor, and a display screen, the method comprising:
setting basic information of a rendezvous event including member information and direction conditions of the rendezvous event;
sending the basic information of the rendezvous event to a back-end system of the host device through the wireless network;
receiving location information of each communication device detected by the GPS, and receiving displacement information of each communication device detected by the displacement sensor;
sending the location information and the displacement information to the back-end system of the host device to determine a rendezvous location, a guide route for each communication device, and relative location relationships of each communication device;
receiving the rendezvous location, the guide route for each communication device, and the relative location relationships of each communication device sent from the host device; and
marking the rendezvous location, the guide route for each communication device, and the relative location relationships on an electronic map, and displaying the marked electronic map on the display screen.

8. The method according to claim 7, wherein the direction conditions of the rendezvous event comprise a shortest distance to the rendezvous location, a shortest time reaching the rendezvous event, and an average distance to the rendezvous location.

9. The method according to claim 7, wherein the rendezvous location is marked on the electronic map using a location indicator, and the location indicator comprising a first indicator indicating the guide route for each communication device, and a second indicator indicating a distance between each communication device and the rendezvous location.

10. The method according to claim 9, wherein the location indicator is an annulus indicator, a circle indicator, a triangle indicator, or a rectangle indicator.

11. The method according to claim 7, wherein the back-end system determines the relative location relationship between each communication device according to the location information of the communication devices, and determines the rendezvous location and a guide route for each communication device according to the direction conditions and the relative location relationships.

12. The method according to claim 7, wherein the member information of the rendezvous event is set using a member information icon, the direction condition of the rendezvous event is set using a direct rendezvous icon, and the location information of each communication device is set using a location information icon.

13. A non-transitory storage medium having stored thereon instructions that, when executed by at least one processor of an electronic device, causes the electronic device to perform a method for updating a rendezvous location of communication devices, the electronic device being connected to a host device through a wireless network, the electronic device comprising a global positioning system (GPS), a displacement sensor, and a display screen, the method comprising:
setting basic information of a rendezvous event including member information and direction conditions of a rendezvous event;
sending the basic information of the rendezvous event to a back-end system of the host device through the wireless network;
receiving location information of each communication device detected by the GPS, and receiving a displacement information of each communication device detected by the displacement sensor;
sending the location information and the displacement information to the back-end system of the host device to determine a rendezvous location, a guide route for each communication device, and relative location relationships of each communication device;
receiving the rendezvous location, the guide route for each communication device, and the relative location relationships of each communication device sent from the host computer; and
marking the rendezvous location, the guide route for each communication device, and the relative location relationships on an electronic map, and displaying the marked electronic map on the display screen.

14. The storage medium according to claim 13, wherein the direction conditions of the rendezvous event comprise a shortest distance from the rendezvous location, a shortest time of the rendezvous event, and an average distance from the rendezvous location.

15. The storage medium according to claim 13, wherein the rendezvous location is marked on the electronic map using a location indicator, and the location indicator comprising a first indicator indicating the guide route for each communication device, and a second indicator indicating a distance between each communication device and the rendezvous location.

16. The storage medium according to claim 15, wherein the location indicator is an annulus indicator, a circle indicator, a triangle indicator, or a rectangle indicator.

17. The storage medium according to claim 13, wherein the back-end system determines the relative location relationship between each of the communication devices according to the location information of the members, and determines the rendezvous location and a guide route for each communication device according to the direction conditions and the relative location relationships.

18. The storage medium according to claim 13, wherein the member information of the rendezvous event is set using a member information icon, the direction condition of the rendezvous event is set using a direct rendezvous icon, and the location information of each communication device is set using a location information icon.
